(19) United States
(12) Patent Application Publication
(10) Pub. No.: US 2019/0005224 A1
(43) Pub. Date: Jan. 3, 2019

(54) Trust Based Computing

(71) Applicant: Nokia Solutions and Networkds Oy, Espoo (FI)

(72) Inventors: Ian Justin OLIVER, Soderkulla (FI); Shankar LAL, Espoo (FI); Leo Tapani HIPPELAINEN, Helsinki (FI)

(21) Appl. No.: 16/063,520

(22) PCT Filed: Dec. 18, 2015
(86) PCT No.: PCT/EP2015/080644

§ 371 Date: Jun. 18, 2018

(51) Int. Cl. G06F 21/44; G06F 9/455; G06F 21/57

(52) U.S. Cl. CPC G06F 21/44; G06F 9/45558; G06F 21/575; G06F 2009/45587; G06F 2009/45595; G06F 2009/45591; G06F 2221/2111

(57) ABSTRACT

A method, an apparatus and a computer program product for trust based computing in a network infrastructure including computing resources. In at least one secure element for attesting trust of one or more of the computing resources, is stored one or more criteria for evaluating trust of location information indicating a location of at least one computing resource. Further is obtained, by the at least one secure element, location information indicating a current location of at least one computing resource; and finally is determined, by a management software, whether the location information of the network infrastructure is secure on the basis of the information indicating the current location and the criteria.

### FIELD OF THE INVENTION

The invention relates to trust based computing in a network infrastructure.

### BACKGROUND OF THE INVENTION

Network function virtualization (NFV) allows virtualizing network node functions into building blocks that may be connected to each other in order to create services for an end-user. Network resources may be grouped into virtual network function (VNF) instances. The VNF may comprise one or more virtual machines (VM) running various software and processes. Because virtual computing resources (VCR) allocation to the virtual machines may cause challenges to security, hardware based secure elements may be used to enable trust in a virtual network infrastructure.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following the invention will be described in greater detail by means of preferred embodiments with reference to the accompanying drawings, in which

FIG. 1 illustrates network architecture according to an embodiment of the invention;

FIG. 2 illustrates an abstracted entity-relationship model showing primary concepts and their relationships;

FIG. 3 illustrate an example of a method to determine whether a network infrastructure is secure;

FIGS. 4A, 4B illustrate systems according to some embodiments of the invention;

FIGS. 5A, 5B illustrate systems according to some embodiments of the invention; and

FIG. 6 illustrates a block diagram of an apparatus according to an embodiment of the invention.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

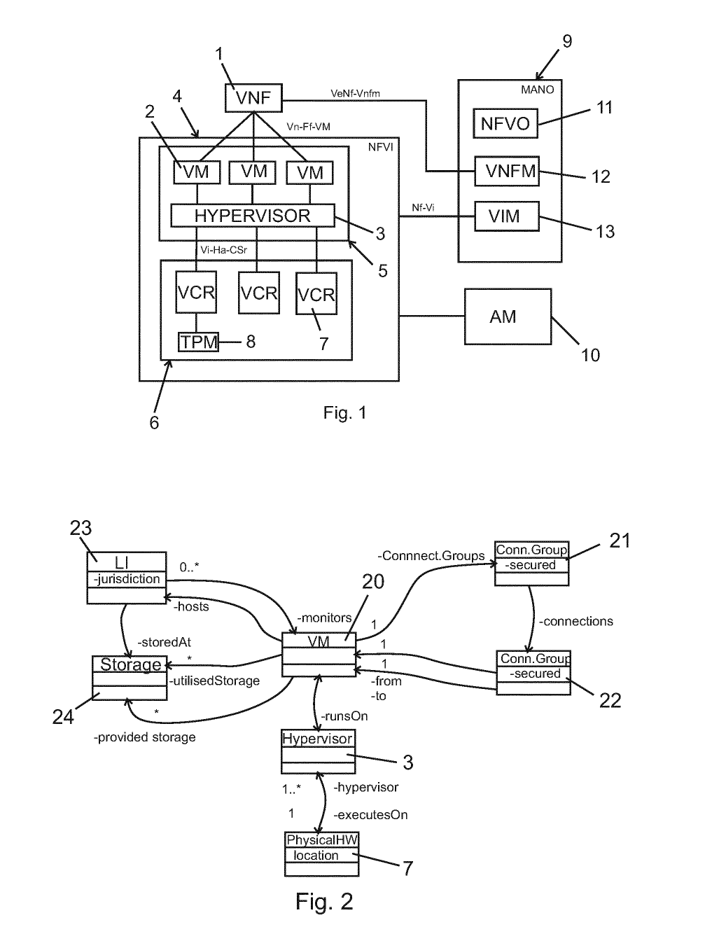

FIG. 1 illustrates a virtual network scenario to which embodiments of the invention may be applied. However, it is apparent to a person skilled in the art that the network to which embodiments of the invention may be applied may be any suitable network. A network function virtualization (NFV) architecture comprising network nodes, e.g. VNF 1, VNF manager 12 (VNFM), NVF orchestrator 11 (NVFO) etc. The network node may be a server computer, host computer, terminal device, base station, access node or any other network element. For example, the server computer or the host computer may generate a virtual network through which the host computer communicates with the terminal device. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer. External network virtualization is targeted to optimized network sharing. Another category is internal virtual networking which provides network-like functionality to the software containers on a single system.

Network resources of the NFV may be grouped into virtual network functions 1 (VNFs) which may comprise one or more virtual machines 2 (VMs). The VNF is a network function capable of running on a network function virtualization infrastructure 4 (NFVI) and being orchestrated by a NFV Orchestrator 11 (NFVO) and a VNF Manager 12 (VNFM). The VNF is created essentially via one or more VMs. The VM is a virtualized computation environment which behaves very much like a physical computer or server. The VM has all its ingredients (processor, memory or storage, interfaces or ports) of a physical computer or server, and is generated by a hypervisor 3, which partitions the underlying physical resources and allocates them to VMs. The hypervisor, also called a virtual machine manager, is a program that allows multiple VMs to share a single hardware host, such as a virtual computing resource 7 (VCR). The interface between the VNF and the VM is called Vn-Nf-VM which is the execution environment of the VNF.

VNFs may be connected or combined together as building blocks to offer a full-scale networking communication service. The VNFs virtualize network services that have earlier being carried out by proprietary, dedicated hardware. The VNF will decouple network functions from dedicated hardware devices and allow network services that have earlier being carried out by routers, firewalls, load balancers and other dedicated hardware devices to be hosted on VMs. When the network functions are under the control of a hypervisor, the services that once required dedicated hardware can be performed on standard servers. Each operating system (OS), appears to have the host's processor, memory, and other resources all to itself. However, the hypervisor is actually controlling the host processor and resources, allocating what is needed to each VM in turn and making sure that VMs cannot disrupt each other. If an application running on the VM requires more bandwidth, for example, the hypervisor could move the VM to another physical server or provision another virtual machine on the original server to take part of the load.

A virtual network infrastructure such as a network functions virtualization infrastructure 4 (NFVI) may comprise all hardware and software components which build up an environment in which VNFs are deployed. The NFVI may span across several locations, e.g. places where data centers are operated. The network providing connectivity between these locations may be regarded to be part of the NFVI. The NFVI may comprise a hypervisor domain 5, a compute domain 6 and an infrastructure network domain. The hypervisor domain may comprise a hypervisor 3 and at least one VM 2. The hypervisor may provide sufficient abstract of the hardware to provide portability of software appliances, may allocate the compute domain resources to the VMs and may provide a management interface to the orchestration and management system 9 (MANO) to allow loading and monitoring of the VMs. The infrastructure network domain may comprise all generic high volume switches interconnected into a network which can be configured to supply infrastructure network services.

The compute domain may be deployed as a number of physical nodes such as virtual computing resources 7 (VCR). The role of the compute domain is to provide the computational and storage resources, when used in conjunction with the hypervisor of the hypervisor domain, needed to host individual components of the VNFs. The compute domain provides an interface to the network infrastructure domain, but does not support network connectivity itself. The computing domain may comprise at least one of following elements: a central processing unit (CPU), a network interface controller (NIC), storage, a server, an accelerator and a trusted platform module 8 (TPM). The CPU is a generic processor which executes the code of a VNF component (VNFC). The NIC provides a physical interconnection with the infrastructure network domain. The storage may be a large scale and non-volatile storage. In practical implementation the storage may comprise spinning disks and solid state disks. The server is a logical unit of compute and may be a basic integrated computational hardware device. An interface called VI-HA-CSr is the interface between the hypervisor and the compute domain serving the purpose of the hypervisor control of the hardware. This interface enables the abstraction of the hardware, BIOS, drivers, NICs, accelerators and memory.

Embodiments of secure elements are a trusted platform module (TPM), virtual trusted platform module (vTPM), software based TMP implementation and combinations of on or off-CPU TPM designs. The TPM 8 disclosed in FIG. 1 may be a computer chip such as a microcontroller that can securely store hashes which may be cryptographically hashed. These hashes may be hashes of passwords, certificates, encryption keys, component measurements etc. The TPM may comprise special registers such as a geolocation platform configuration register (PCR) to store location information. In addition the TPM may also be used to store platform measurements that help to ensure that the platform remains trustworthy. Authentication ensures that the platform is what it claims to be and attestation is a process helping to prove that a platform is trustworthy and has not been breached. TPMs may be used in computing devices such as network equipment. Software can use a TPM to authenticate hardware devices such as virtual computing resources. Since each TPM chip has a unique and secret key burned in as it is produced, it is capable of performing platform authentication. Generally, pushing the security down to the hardware level in conjunction with software provides more protection than a software-only solution. Trusted computation and geographical trust in the NFV environment is critical to proper provisioning of service in compliance with lawful intercept legislation (LI), data handling legislation and data sovereignty. For example Russian and Indian laws prevent cross-border data transmission for certain classes of data. To secure the virtual network infrastructure better a geographically trusted boot with combined attestation of a location, an asset management (AM) and other sources may be provided with the help of the TPM.

FIG. 1 may further comprise a management and orchestrator node 9 (MANO) and an asset management node 10 (AM). Geographical location of virtual computing resources may be stored to the AM. The MANO may comprise following functional blocks; a NFV orchestrator 11 (NFVO), a VNF manager 12 (VNFM) and a virtualized infrastructure manager 13 (VIM). The NFVO is responsible for allocating resources and/or for instantiating, monitoring or terminating VNF instances and policy management for a network service (NS) instances. The VNFM is responsible of lifecycle management of VNF instances and has an overall coordination and adaptation role for configuration and event reporting. The VIM is controlling and managing the NFVI compute, storage and network resources, within one operator's infrastructure sub-domain and collecting and forwarding performance measurements and events. The hypervisor does not implement network services without the VIM knowing or instructing the hypervisor domain. The interface between the hypervisor domain and the VIM is called NF-Vi and the interface between the VNF and the VNFM is called VeNf-Vnfm.

Trusted base computing is a known method for ensuring that an operating system instance or configuration is according to a given norm by attestation and validation through a secure element which provides the necessary cryptographic and hashing functions to achieve this. The secure element may be a TPM as described above. The network operator has to trust sufficiently to a network infrastructure of a hosting provider to run the secure elements on it, and the network infrastructure will similarly want to be able to check that the secure elements are genuine. The network infrastructure may be a virtual network infrastructure. To make the network infrastructure more secure, storage of asset management and/or geographical attributes in the network infrastructure should be possible. However these do not integrate beyond the current O/S boot time and underlying hardware. Therefore is provided a secure network infrastructure by combining attestation of location, asset management and other sources.

FIG. 2 illustrates an embodiment of an abstracted entity-relationship model showing primary concepts and their relationships. The entity-relationship diagram has been written as an UML Class Diagram. A piece of physical hardware such as a virtual computing resource 7 (VCR) comprising a CPU, a memory, an physical disks, may run at least on a hypervisor 3 which in turn may run at least one VM 20. The VM may be connected to at least one connection group (CG) 21, 22. The VCR may have a geographical location assigned by some means, for example by asset tagging and an associated system, or via a trust mechanism such as a secure element like a TPM. FIG. 2 may present a generic concept of connections which represents all the various forms of connection between any pair of the VMs. The connections may be network connections such as Internet Protocol connections. The VMs may be connected as a group which may be secure if and only if all individual connections within that group are secure. Storage 24 may be rooted by the VM. When the VM utilizes the storage which has been provided by another VM, it implies that a connection exists between these two VMs. When the VMs are organized as a connection group a whole connection path exists via an intermediate VM through which the connection is arranged to the other VM. A simple direct connection between two VMs may imply that the connection group has a single connection. A complex connection between two VMs may imply that the connection group may have multiple connections forming a path via one or more intermediate VMs and the intermediate VMs may process the connection. Such intermediate VMs may be firewalls, SDN routers or other kind of functionalities.

FIG. 2 illustrates further a legal interception (LI) entity 23 which may denote all the necessary functionalities for enabling, managing and providing a LI trace. The LI entity may monitor VMs which means that the LI entity may monitor functionality, an entity and/or a person contained therein and defined by the scope of the LI itself. The collected data may be stored in the storage. The LI entity may be VM, VM functionality or some other entity. The LI entity is issued within the scope of a jurisdiction which defines a given operational area. The LI entity may be hosted by some VM, which may or may not be the same VM that is being monitored.

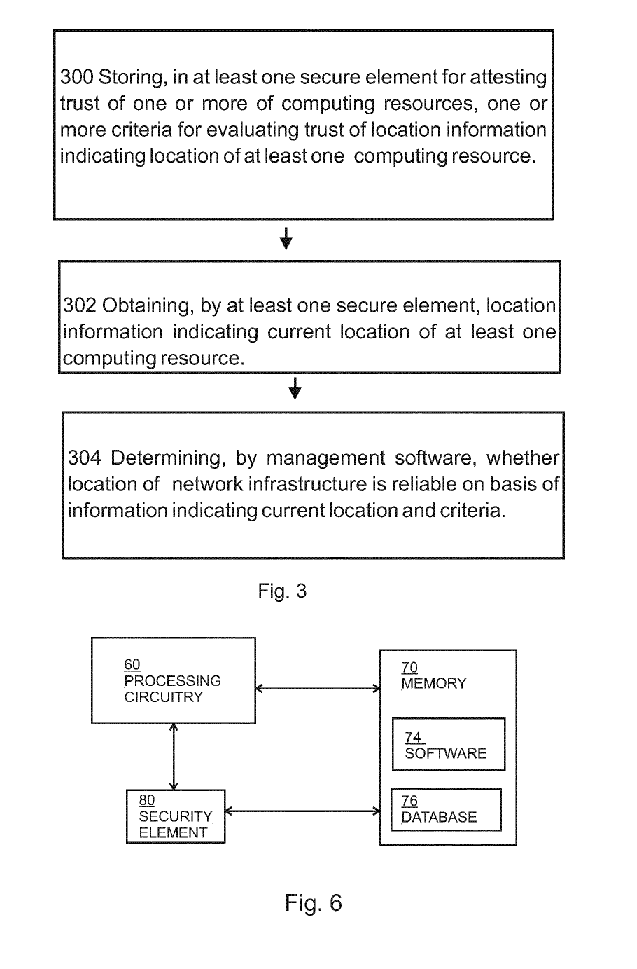

Let us now describe an embodiment of the invention for trust based computing in network infrastructure, which may be a virtual network infrastructure such as a NFV infrastructure (NFVI) with reference to FIG. 3. The network infrastructure may comprise virtual computing resources (CR). The computing resources may comprise physical hardware such as a CPU and storage for executing the computation for VMs. FIG. 3 illustrates a method wherein at least one secure element, for attesting trust of one or more of the computing resources, may be configured to store 300 one or more criteria for evaluating trust of location information indicating a location of at least one computing resource. In an embodiment there may be several different secure elements such as TPM, smart card etc. In an embodiment the secure element may be a trusted platform module. Further in an embodiment one or more criteria may comprise a location. In another embodiment one or more criteria may comprise a location and at least one of the following: an asset tag, a serial number, a network address, keys, hashes, identification information and configuration information which may be tagged with its provenance. The one or more criteria may be stored during physical system installation like during hardware installation. Saving may be done by trusted persons or systems and the criteria may be saved into a secure element, a TPM, a MANO and/or an AM system. If saving of the one or more criteria to the secure element or the TPM and the AM has been done independently, then cross-checking of the said criteria may be done via the AM system.

The at least one secure element may obtain 302 location information indicating a current location of at least one computing resource. The current location may be queried during a component migration, during boot of computing resources or at any time. In an embodiment current location information may be obtained by at least one of methods: operator interaction through a location information register, a link layer address, a smart card, a keyboard, Global Positioning System, indoor positioning, a request to an asset management system, a request to a network management and orchestration system (MANO), a secure element, a network address (such as Internet Protocol address). A location information register may be a memory storing the exact location information of at least one computing resource. In an embodiment the means may be prioritized. For example a location provided by an operator may have a greater weight in trust than one provided by any device.

Finally the management software may determine 304 whether the location information of the network infrastructure is reliable on the basis of the information indicating the current location and the criteria. In an embodiment the management software may be MANO or some other management software having algorithms to inquire current location into from various available sources and then to conclude the location. The algorithm should take into account reliability and priority of each location provider and in a case of contradiction among various sources, decide the most probable location or raise a flag that the location cannot be trusted. In an embodiment reliability of the location information may be determined on the basis of location information that may be internal to the secure element and information indicating a location from at least one external system. The information indicating the location from at least one external system may be obtained by at least one of: a request to an asset management system, a request to a MANO, a trusted device, a network address. In an embodiment the current location may be reported to at least one entity of the network infrastructure, NFVO or AM. The current location may also be used for network slicing or network partitioning. Further in an embodiment a security element may perform at least one location based policy which may be determined based on the reliability information.

In an embodiment the trust may be attested according to a following example. A current location (cl) may be obtained as described above. The location may be processed to a form p(cl) to be attestable by a security element. Processing may comprise at least one of processing methods: hashing (such as cryptographic hashing), encryption, reformatting of the location (e.g. datum calculations or normalisation), extraction of operational location area (e.g. coordinates and country), differential privacy, I-diversity or other obfuscation function and error correction. Finally the value p(cl) may be passed to the security element for checking it against the stored location. If the values are within suitable bounds the security element may validate and return a positive result.

In an embodiment the trust may be attested by querying the AM a current location. If the location of the AM asset tag does not match the value stored in the security element then the location may not be trusted. In an embodiment the trust may also be attested by querying the NFVO for policies related to the location and/or granularity of location. If the provided value does not match the given policy then the location may not be trusted. Further in an embodiment a combination of different methods may be used to attest the current location. For example, upon receipt of the current location (cl) as described above and any subsequent, necessary processing resulting in p(cl), this may also be matched against the location provided by the asset tag, p(cl_asset). Further locations may be obtained from IP/Routing p(cl_ip) or querying from the NFVO the last known location p(cl_last). Once a set of locations L is provided comprising at least one values mentioned above, a function may be employed over these to calculate a single value for query against the value stored in the security element. The security element may also have multiple stored values.

In an embodiment wherein a computing resources comprise virtual computing resources and when computing resources are allowed based on the location information, virtual computing resource mobility may be allowed inside an allowed location area. In an embodiment wherein a computing resources comprise virtual computing resources and the network infrastructure comprise a virtual network infrastructure and if it is determined that the virtual computing resources are not allowed, virtual computing resource mobility may be blocked. Even if computing resources cannot be considered entirely secure, it does not mean that operation should necessarily be terminated. There are occasions where less secure situations may be acceptable such as: partitioning network connecting virtualized network functions (VNFs) served by virtual computing resources, or partitioning a virtual network infrastructure at the level of virtual machine managers such as hypervisors.

In an embodiment VMs may be moved between data centers, hypervisors etc. when a load balancing and other requirements dictate. Further in an embodiment a location based policy may be determined by an operational area of a Legal Interception (LI) function and/or at least one geographically dependent workload. The authorities may limit on which geographical area a certain requester is allowed to run LI and thus complicating and restricting VM mobility. Following algorithms are examples which may be used to determine the secure mobility:

```
moveVM(v:VM, h:Hypervisor ):
// v is the VM to be moved, h is the target hypervisor
pre:
//avoid the nonsensical, already running on this hypervisor case
      v.runsOn != h
then:
      v.runsOn = h
```

If VM is running on a trusted hardware, it must be ensured that the VM is moved to a similarly trusted hardware:

```
moveVM(v:VM, h:Hypervisor ):
pre:
      v.runsOn != h
      h.executesOn.trusted = true
then:
      v.runsOn = h
```

VM is moved to the trusted hardware if trust measurements are valid.

If the VM in question is being moved with respect to a geographical location then the following algorithm may be used:

```
moveVM(v:VM, h: Hypervisor );
pre:
      v.runsOn != h
      h.executesOn.trusted = true
      v.executesOn.geographicalLocation IN v.hosts.jurisdiction
then:
      v.runsOn = h
```

In this case a location based policy is determined by an operational area of the LI. It should be checked that the operational area of the target physical hardware is still within the same jurisdiction of the hosted LI monitoring.

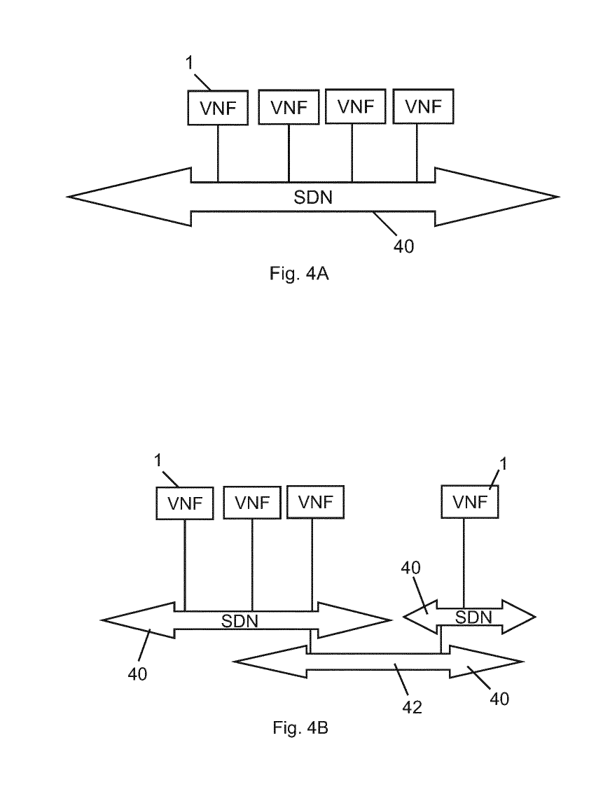

FIG. 4A illustrates an embodiment of a system which may comprise VNFs 1 and an underlying software defined network (SDN) 40. A network routing may be provided by the SDN. FIG. 4B shows how the SDN 40 may be effectively split to prevent untrusted components to be mixed with trusted components. This is particularly important in VNF/VM mobility policies. If the VNF 1 requires certain geographical trust such as LI or similar, it may cause a problem of trust. A loss of trust may cause a SDN layer to partition the network into two sections with an element 42 (such as a switch, a bridge or a filter) for monitoring and controlling network traffic between the two sections. As a result the network connecting VNFs served by virtual computing resources may be partitioned.

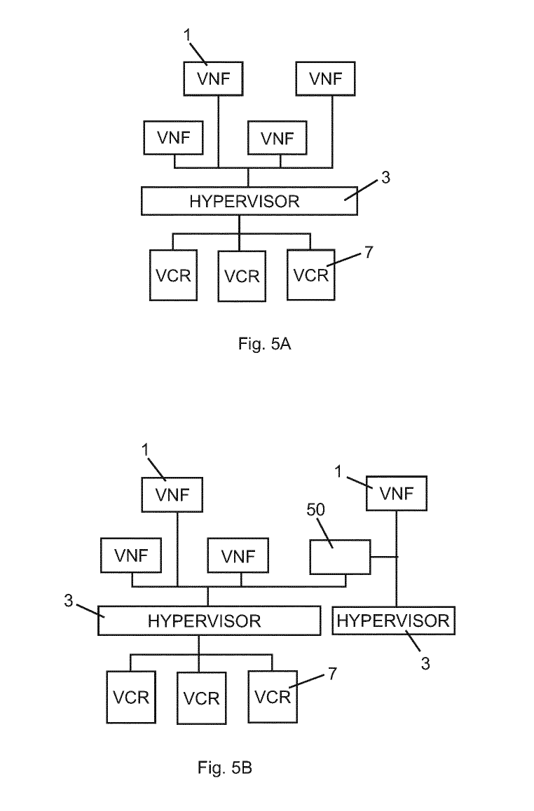

FIG. 5A illustrates an embodiment of a system which may comprise VNFs 1, hypervisor 3 and virtual computing resources 7 (VCR). FIG. 5B shows how a virtual network infrastructure may be partitioned at a hypervisor 3 level as a result of lost trust. The virtual network infrastructure may be split into two separate clouds with controlled routing of information between them. Routing may be done with an element 50 such as a bridge which may comprise a virtualized SDN, a firewall or any suitable technology providing some form of linkage if necessary. In an embodiment a combination of the SDN split (FIG. 4B) versus hypervisor split (FIG. 5B) solutions may also be done depending upon various characteristics of the cloud, networking etc. The NFV orchestrator within the MANO may make the decisions for partitioning the VNFs or the virtual network infrastructure which may involve communication between VNF managers, virtual infrastructure managers and additional NANO components such as security orchestrators and attestation. There may also be communication with network elements such as (SDN) switches, bridges, routers, controllers and network functionality.

The trust may be computed at boot-time or it may be requested at any time during the operating of a system. This may be marshalled by MANO, a security orchestrator (OS) or any other relevant component.

An embodiment provides an apparatus comprising at least one processor and at least one memory including a computer program code, wherein the at least one memory and the computer program code are configured, with the at least one processor, to cause the apparatus to carry out the procedures of the above-described computing resource (CR), e.g. in the process of FIG. 3. The at least one processor, the at least one memory, and the computer program code may thus be considered as an embodiment of means for executing the above-described procedures of the computing resource. FIG. 6 illustrates a block diagram of a structure of such an apparatus. The apparatus may be comprised in a computing resource of a network infrastructure. The processing circuitry 60 may comprise at least one processor. The memory 70 may store one or more computer program products 74 comprising program instructions that specify the operation of the processor. The apparatus may further comprise a security element 80 such as a trusted platform module (TPM). It may be a computer chip such as a microcontroller that can securely store artifacts used to authenticate the computing resource. These artifacts may comprise passwords, certificates, or encryption keys. TPM may also store criteria and current location measurements in to a platform configuration register (PCR). The criteria and measurements may also be stored in a database 76 stored in the memory 70 of the apparatus. The circuitries 60 to 80 of the computing resources may be carried out by the one or more physical circuitries or processors. In practice, the different circuitries may be realized by different computer program modules. Depending on the specifications and the design of the apparatus, the apparatus may comprise some of the circuitries 60 to 80 or all of them.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described above in connection with FIGS. 2 to 5 may also be carried out in the form of one or more computer process defined by one or more computer programs. The computer program shall be considered to encompass also a module of a computer programs, e.g. the above-described processes may be carried out as a program module of a larger algorithm or a computer process. The computer program(s) may be in source code form, object code form, or in some intermediate form, and it may be stored in a carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

It will be obvious to a person skilled in the art that, as the technology advances, the inventive concept can be implemented in various ways. The invention and its embodiments are not limited to the examples described above but may vary within the scope of the claims.

1. A method, the method comprising:
storing, in at least one secure element for attesting trust of one or more computing resources, one or more criteria for evaluating trust of location information indicating a location of at least one computing resource;
obtaining, by the at least one secure element, location information indicating a current location of at least one computing resource; and
determining, by a management software, whether the location information of a network infrastructure is reliable on the basis of the information indicating the current location and the criteria.

2. A method according to claim 1, wherein reliability of the location information is determined on the basis of location information that is internal to the security element and information indicating location from at least one external system.

3. A method according to claim 1, wherein storing one or more criteria, in the at least one secure element, is done during physical system installation.

4. A method according to claim 1, wherein the one or more criteria comprise a location.

5. A method according to claim 4, wherein one or more criteria further comprise at least one of: an asset tag, a serial number, a network address, keys, hashes, identification information and configuration information.

6. A method according to claim 1, wherein the current location information is obtained through at least one of the following: a location information register, a link layer address, a smart card, a keyboard, a Global Positioning System, indoor positioning, a request to an asset management system, a request to a network management and orchestration system, a secure element and a network address.

7. A method according to claim 6, wherein current location obtained through the means is prioritized.

8. A method according to claim 1, the method comprising:
performing, by the at least one security element, at least one location based policy based on the determined reliability information.

9. A method according to claim 8, wherein the computing recourses comprise virtual computing resources and the network infrastructure comprise a virtual network infrastructure, and when it is determined that the virtual computing resources are not allowed
blocking virtual computing resource mobility,
partitioning network connecting virtualized network functions served by the virtual computing resources, or
partitioning the virtual network infrastructure at the level of virtual machine managers.

10. A method according to claim 8, wherein the computing recourses comprise virtual computing resources and when the virtual computing resources are allowed based on location information allowing virtual computing resource mobility inside a permitted location area.

11. A method according to claim 8, wherein the location based policy is determined by an operational area of the Legal Interception function and/or at least one geographically dependent workload.

12. A method according to claim 1, wherein the current location is reported to at least one entity of the network infrastructure.

13. An apparatus comprising
at least one processor; and
at least one memory including a computer program code, wherein the at least one memory and the computer program code are configured, with the at least one processor, to cause the apparatus to
store, in at least one secure element for attesting trust of one or more computing resources, one or more criteria for evaluating trust of location information indicating a location of at least one computing resource;
obtain, by the at least one secure element, location information indicating a current location of at least one computing resource; and
determine, by a management software, whether the location information of a network infrastructure is reliable on the basis of the information indicating the current location and the criteria.

14. An apparatus according to claim 13, wherein reliability of the location information is determined on the basis of location information that is internal to the security element and information indicating location from at least one external system.

15. A computer program product comprising a non-transitory medium readable by an apparatus and comprising program instructions which, when loaded into an apparatus, cause the apparatus to perform at least the following:
storing, in at least one secure element for attesting trust of one or more computing resources, one or more criteria for evaluating trust of location information indicating a location of at least one computing resource;
obtaining, by the at least one secure element, location information indicating a current location of at least one computing resource; and
determining, by a management software, whether the location information of a network infrastructure is reliable on the basis of the information indicating the current location and the criteria.

16. (canceled)

17. An apparatus according to claim 13, wherein storing one or more criteria, in the at least one secure element, is done during physical system installation.

18. An apparatus according to claim 13, wherein the one or more criteria comprise a location.

19. An apparatus according to claim 13, wherein the current location information is obtained through at least one of the following: a location information register, a link layer address, a smart card, a keyboard, a Global Positioning System, indoor positioning, a request to an asset management system, a request to a network management and orchestration system, a secure element and a network address.

20. An apparatus according to claim 13, wherein the at least one memory and the computer program code are further configured, with the at least one processor, to cause the apparatus to
perform, by the at least one security element, at least one location based policy based on the determined reliability information.

21. An apparatus according to claim 13, wherein the current location is reported to at least one entity of the network infrastructure.
